(19) United States
(12) Patent Application Publication
(10) Pub. No.: US 2004/0131364 A1
(43) Pub. Date: Jul. 8, 2004

(54) 3R regenerator with wavelength conversion

(76) Inventor: Bernd Sartorius, Berlin (DE)

Correspondence Address: Law Offices of Karl Hormann, PO Box 381516, Cambridge, MA, 02238, US

(21) Appl. No.: 10/474,249

(22) PCT Filed: Apr. 4, 2002
(86) PCT No.: PCT/DE02/01340

(30) Foreign Application Priority Data
Apr. 10, 2001 (DE) 101189583

(51) Int. Cl. H04B 10/02

(52) U.S. Cl. 398/175

(57) ABSTRACT

[The aim of the invention is to realize both 3R regeneration as well as an adjustable wavelength conversion with one component. The 3R regenerator should be constructed with components that are less technically complex than those of the prior art. In a] A 3R regenerator which is provided with wavelength conversion and which comprises means for generating clock pulses, a non-linear discriminator, and means for generating and/or adjusting the output wavelength, [the invention provides that] the means for generating and/or adjusting the output wavelength [is] being a laser. [This laser, in addition to the means for generating clock pulses to the discriminator, is constantly operated, is connected to the discriminator, and its light having the desired wavelength is beamed into the discriminator. A delay line is located between the means for generating clock pulses and the discriminator. One pulse at a time of the data signal, which is delayed over the optical delay line by approximately a half bit, is placed in the temporal gap between each two pulses of the clock signal. In order to prevent interferences, the pulses of the data signal and clock signal, and the emitted laser radiation have a different wavelength or polarization or beam direction. In addition, a means for adjusting the power of the data pulse and clock pulse is arranged before the discriminator, and is used to adjust these powers so that the action upon the non-linear discriminator is approximately equal and permits assured switching of the discriminator.]

### BACKGROUND OF THE INVENTION

1. Field of the Invention

The invention relates to a 3R regenerator with wavelength conversion provided with means for generating clock pulses, a non-linear discriminator and means for generating and/or adjusting the output wavelength.

2. The Prior Art

Optical regeneration (re-amplification, i.e., amplitude of the signal; reshaping, i.e., shape of the signal; re-timing, i.e., temporal position of the signal) is a key function of transparent optical data nets. The most important function blocks are the regeneration of pulses, which generates a stream of light pulses which is synchronized to a data signal, and the discriminator element which has an approximately digital switching function for distinguishing between noise and signal pulses. Another parameter important in the context of wave division multiplexing is the output wavelength of the regenerated signal. This must fit precisely into the standardized wavelength raster and, within it, it should be freely selectable to the greatest possible extent.

The discriminator element utilized in the standard structure of an optical 3R regenerator is a non-linear optical switch which is energized by a data signal and which blocks or passes the clock pulses depending upon whether they are “0” or “1” bits (in this connection, see, e.g., ECOC 2000, Munich, invited paper We 9.4.1, Conf. Dig. We pp. 293-296). Re-timing and re-shaping are accomplished by the switching window being temporally wider than the clock pulses. Thus, pulse shape and temporal jitter in the data signal are not transmitted to the pulse shape and time slot of the output signal, the shape and time slot of which is influenced only by the clock pulses. The wavelength of the output signal is also defined by the clock pulses. For each wavelength within the raster it is thus necessary either to produce a special pulse regenerator which is a complex component or additional wavelength conversion must be provided at the output of the 3R regenerator.

Digitally switchable lasers are used as discriminator elements in other 3R regenerators, as described, for instance, in ELECTRONIC LETTERS 28^{th} September 1989, Vol. 25, No. 20, pp. 1332-1333 and SPIE Vol. 2954, pp.30-41. In that case, such a discriminator laser, which is also a complex structural component, defines the output wavelength of the 3R regenerator. Here, too, it is necessary either to manufacture a suitable discriminator for every wavelength or to provide additional wavelength conversion at the output.

It is also known in the prior art to utilize typically interferometric structures with semi-conductor amplifiers as non-linear discriminator elements. Interferometers with but one semi-conductor amplifier, for instance the generally known “UNI” and “SLALOM” structures, may be realized in a simple manner and are operable in a stable manner. In this connection, the asymmetric “delayed interference” interferometer, as it has been described in OFC 2000, Postdeadline Paper PD17-1 to 17-3, is, overall, the most advantageous structure. Its semi-conductor amplifier is not located inside the interferometer but ahead of it. For that reason, semi-conductor amplifier and asymmetric interferometer network may, without problems, be made of different materials and be separately optimized. In this connection, it is only in respect of the semi-conductor amplifier that independence of polarization is significant. Aside from the mentioned advantages, this interferometer suffers from the drawback that the controlled signal must always be a constant signal. For that reason, the conventional 3R regenerator with the discriminator as the switch for the clock pulses cannot be of the advantageous interferometric structure.

OFC, Technical Digest, Th F7-1/93 to Th F7-3/93 describes a 3R regenerator with wavelength conversion which in two separate function blocks respectively realizes a 3R regeneration and a wavelength conversion to a DFB laser. For the 3R regenerator, the described arrangement is provided with means for generating pulses and a non-linear discriminator and a further non-linear function element and a DFB laser as the means for generating and/or setting a desired wavelength. As a result of the necessary a second function block for the wavelength conversion, the described system is technically complex as well as dear.

### OBJECT OF THE INVENTION

The object of the invention is to provide a 3R regenerator with an adjustable output wavelength, i.e. both 3R regeneration and adjustable wavelength conversion are to be possible with a single component. By comparison with prior art arrangements, the 3R regenerator is to be technically realizable with fewer complex components.

### BRIEF SUMMARY OF THE INVENTION

In a 3R regenerator of the kind referred to supra, the object is accomplished by the means for generating and/or adjusting the output wavelength is a constantly driven laser added to the clock pulse generation means and to the discriminator, the laser being connected to, and injecting its light of desired wavelength into, the discriminator, that between the clock pulse generation means and the discriminator there is arranged a delay line for injecting each pulse of the data signal with a delay of about one half bit into the time slot between two pulses of the clock signal, the pulses of the data and clock signals and of the injected constant signal being of different wavelengths or polarization or direction to avoid interferences and means for adjusting the power of the data and clock pulses being arranged ahead of the discriminator for adjusting the power such that its effect on the non-linear discriminator is approximately uniform and that the discriminator may be switched with certainty.

In addition to the pulse generator and the non-linear switch acting as discriminator, the arrangement in accordance with the invention for realizing 3R regeneration requires only one constantly driven external laser of the new target wavelength. These required simple lasers are manufactured in large quantities in the necessary wavelength raster and may be cost-efficiently obtained. Wavelength tuneable lasers which have since become available may also be used in connection with the arrangement of the invention. They make it possible to adjust the 3R regenerator to any desired output wavelength.

The previously mentioned delay line makes it possible to realize in the discriminator element to place the data pulses, delayed by about one half bit, into the time slot between two clock pulses and thus to inject them into the discriminator element (alternating pulse data gating). For the purpose of avoiding interferences and of combining or adding only the power of the data and clock pulses, the data and pulse signals differ in terms of their wavelength or polarization or the direction in which they are injected into the discriminator element. The power of these pulses is realized by the power setting means such that their effect on the discriminator element is approximately uniform, i.e. effects as a result of differing wavelength or polarization or the direction of propagation are thus substantially compensated by a suitable power adjustment. The further effect of these power setting means is that one signal alone (clock or data signal) suffices to exceed the discriminator threshold and to release the discriminator function and that the limited smaller power deviations do not detrimentally affect the release of the discriminator function because of signal degradation. The transfer fo the combined data clock signal to this new wavelength takes place in the discriminator element into which the additional external laser pumps its constant signal of the desired output wavelength. The arrangement in accordance with the invention may be realized by means which by comparison to the state of the art are of low complexity.

In different embodiments of the invention, the additional laser may be a laser of constant wavelength are a laser tuneable in respect of its wavelength, or it may be monolithically integrated into the discriminator element.

In other embodiments of the invention, the non-linear discriminator may be a semiconductor amplifier, such as, for instance, a semiconductor amplifier the band gap of which is shifted such that it is substantially transparent in the range of the controlled signal, or a saturable absorber or an electro-absorption waveguide or a non-linear fiber or a non-linear crystal.

For optimizing the interference behavior, the non-linear discriminator is combined with an interferometer which may be asymmetrically delayed or operated differentially.

An awareness of the arrangement in accordance with the invention makes it possible to apply the mentioned advantageously structured asymmetric “delayed interference” interferometer also in 3R regeneration.

In the 3R regenerator in accordance with the invention the output signal is logically inverted. For that reason, another embodiment provides for a dual-stage arrangement for resetting the inverted signals.

### DESCRIPTION OF THE SEVERAL DRAWINGS

[The invention will hereafter be described in greater detail with reference to the drawings, in which:] The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawings, in which:

FIG. 1 schematically depicts the structure of an adjustable wavelength 3R regenerator in accordance with the invention; and

FIG. 2 depicts the pulse sequence ahead of and following the discriminator.

### DETAILED DESCRIPTION OF THE PREFERRED EMBODIMENT

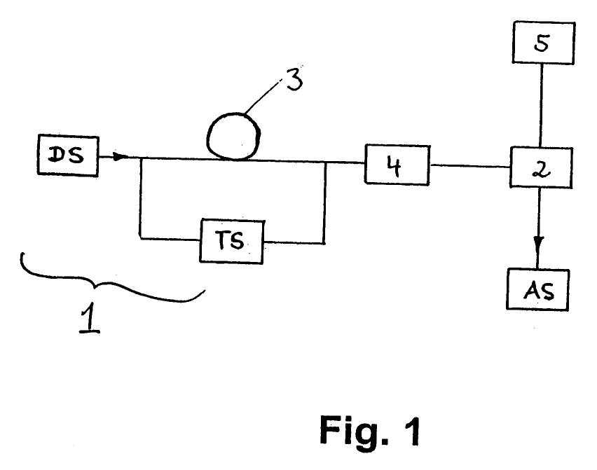

As shown in FIG. 1, the data signal DS is injected into the means 1 for regenerating pulses. A delay line 3 is arranged between the pulse regenerator 1 and the discriminator 2. Also ahead of the discriminator 2, there is provided a means for setting the power 4 of the data signals DS and clock signals TS. The discriminator 2 is connected with a constantly operated laser 5.

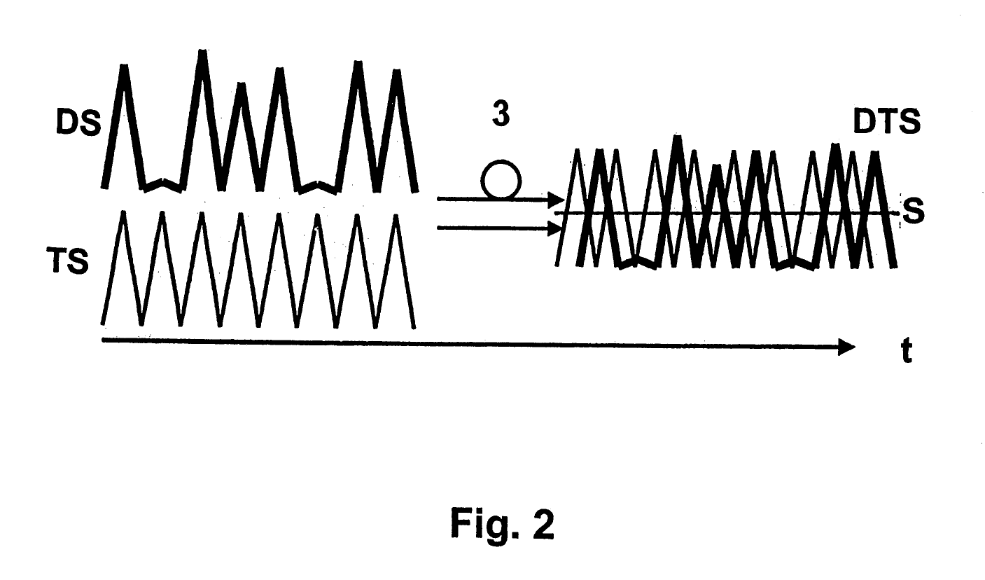

If the data signal DS has a “1” bit, an alternating energization of data signals DE and clock signals TS of the discriminator 2 is realized by the mentioned delay line 3, as shown in FIG. 2. The means 4 for setting the power of the data signals DE and clock signals TS then ensures an almost uniform power level. The discriminator 2 is thus constantly maintained in a defined state. Small deviations in the power as a result of data degradation are held back by the threshold function of the discriminator 2.

If the data signal DS is a “0” bit one, the power in the combined alternating data-clock-signal DTS drops below the threshold S of the discriminator and the discriminator 2 switches to its other state. The instant of re-timing and the re-shaping are dependent solely upon the time slot and shape of the adjacent clock pulses as well as the transitional shape of the discriminator 2, and—up to certain limits—they are not affected by degradation (time, jitter and amplitude fluctuations) of the data signal. This results in the realization by the inventive arrangement of the re-timing and re-shaping necessary for the 3R regeneration. In the same arrangement, in the discriminator element 2 into which the constant signal for the desired output wavelength is injected by the additional external laser 5, the transfer takes place of the combined data-clock-signal DTS to the new wavelength at which the output signal AS exits from the arrangement in accordance with the invention.

In the arrangement in accordance with the invention a logic inversion of the data, i.e. “0” bits are changed to “1” bits and vice versa. In some applications, the possibility of inversion may be used in a positive way, or it may be reset by a dual-stage arrangement.

Application of the arrangement in accordance with the invention requires the development of only one type of pulse regenerator and one type of discriminator for regeneration of different output wavelengths. The output wavelength may be set rigidly by an inexpensive additional component and electrically variable by a tuneable laser.

In the arrangement in accordance with the invention of the 3R regenerator of adjustable output wavelength the discriminator may be composed of very different non-linearly functioning elements, i.e., not only components of a switching function may be used for the pulses. In principle, any arrangement providing for non-linear wavelength conversion to a uniform signal may be expanded to a 3R regenerator of and adjustable output wavelength by the arrangement in accordance with the invention.

What is claimed is:

1. A 3R regenerator with wavelength conversion provided with means for the generation of pulses, a non-linear discriminator and means for generating and/or setting the output wavelength
characterized by the fact that
the means for generating and/or setting the output wavelength is a laser uniformly driven (5) in addition to the means for regenerating pulses (1) and the discriminator (2) which is connected to the discriminator (2) and which injects its light thereinto at the desired wavelength, that a delay line (3) is arranged between the means for regenerating pulses (1) and the discriminator (2) and by means of which a pulse of the data signal (DS) is placed into the time slot between two pulses of the clock signal (TS) by the delay line (3) at a delay of about half a bit, the pulses of the data signal (DS) and the clock signal (TS) and the uniform laser signal being of different wavelengths or polarization or direction of propagation to prevent interferences, and that means for setting the power (4) of the data signals (DS) and clock signals (TS) is arranged ahead of the discriminator (2) for setting the power such that their effect on the non-linear discriminator (2) is approximately uniform and that the discriminator (2) may be assuredly switched.

2. The 3R regenerator of claim 1,
characterized by the fact that
the additional uniformly driven laser (5) is a laser of constant wavelength.

3. The 3R regenerator of claim 1,
characterized by the fact that
the additional uniformly driven laser (5) is a laser tuneable in its wavelength.

4. The 3R regenerator of claim 1,
characterized by the fact that
the additional uniformly driven laser (5) is monolithically integrated with the discriminator (2).

5. The 3R regenerator of claim 1,
characterized by the fact that
the non-linear discriminator (2) is a semiconductor amplifier.

6. The 3R regenerator of claim 5,
characterized by the fact that
the non-linear discriminator (2) is a semiconductor amplifier the band gap of which is shifted such that in the range of the controlled signal it is substantially transparent.

7. The 3R regenerator of claim 1,
characterized by the fact that
the non-linear discriminator (2) is a saturable absorber.

8. The 3R regenerator of claim 1,
characterized by the fact that
the non-linear discriminator is an electro-absorption waveguide.

9. The 3R regenerator of claim 1,
characterized by the fact that
the non-linear discriminator (2) is a non-linear fiber.

10. The 3R regenerator of claim 1,
characterized by the fact that
the non-linear discriminator (2) is a non-linear crystal.

11. The 3R regenerator of [one of claims 5 to 10] claim 1,
characterized by the fact that
the non-linear discriminator (2) is combined with an interferometer.

12. The 3R regenerator of claim 1,
characterized by the fact that
the interferometer is asymmetrically delayed.

13. The 3R regenerator of claim 11,
characterized by the fact that
the interferometer is operated differentially.

14. The 3R regenerator of claim 1,
characterized by the fact that
a dual-stage arrangement is provided for resetting the inverted signals.
